(19) United States
(12) Patent Application Publication
(10) Pub. No.: US 2013/0315277 A1
(43) Pub. Date: Nov. 28, 2013

(54) Method for Evaluating Additives Useful for Improving the Efficiency of Heat Transfer in a Furnace and Systems for Performing Same

(71) Applicants: Zhenning GU, Sugar Land, TX (US); Corina L. Sandu, Pearland, TX (US); James Michael Brown, Lago Vista, TX (US)

(72) Inventors: Zhenning GU, Sugar Land, TX (US); Corina L. Sandu, Pearland, TX (US); James Michael Brown, Lago Vista, TX (US)

(73) Assignee: Baker Hughes Incorporated, Houston, TX (US)

(21) Appl. No.: 13/898,292

(22) Filed: May 20, 2013

Related U.S. Application Data
(60) Provisional application No. 61/650,212, filed on May 22, 2012.

(51) Int. Cl. G01N 25/00

(52) U.S. Cl. CPC G01N 25/00
USPC 374/9

(57) ABSTRACT

Additives for improving furnace heat transfer efficiency may be effectively screened for effectiveness by heating the additive, optionally mixed with ash, to the operating temperature of the furnace and measuring its relative emissivity. Additives that have lower emissivity at furnace operating temperatures may be useful for improving furnace heat transfer efficiency as compared to those that have higher emissivity.

### CROSS REFERENCE TO RELATED APPLICATIONS

This application claims priority from the U.S. Provisional Patent Application filed on May 22, 2012 having the file application Ser. No. 61/650,212 which is incorporated herein by reference in its entirety.

### BACKGROUND OF THE INVENTION

1. Field of the Invention

The present invention relates to additives for improving heat transfer in furnaces. The present invention particularly relates to furnaces wherein the internal surface is partially or completely covered by ash and/or residue from combustion of fuels and methods for evaluating the additives for their ability to improve heat transfer.

2. Background of the Art

Petrochemical plants, oil refineries, power generation stations, and the like; all utilize furnaces for heat and/or steam generation. For centuries, man has relied upon the combustion of combustible materials, such as coal and wood, to provide heat energy. One of the most common methods for harnessing this heat energy is to use the heat energy to generate steam or heat other types of fluids.

Over the years, different types of furnaces or boilers have been developed for the combustion of coal, wood, and other combustible materials. In the late 1940's and early 1950's, there was a large decline in the demand for commercial and industrial solid fuel-fired systems due to the wide-spread availability of relatively cheap oil and natural gas sources. Thus, the oil and gas-fired systems substantially replaced the coal-fired systems until the gas and oil petroleum-based fuels became less plentiful during the 1970's. The petroleum shortage experienced during the 1970's and the very high prices of the late 2000's have made coal-fired and other solid fuel-fired systems very attractive once again.

In recent years, considerable emphasis has been given to solid fuel research, particularly in the area of burning solid fuels such as coal and wood without excessive pollutant emissions and with increased heat transfer efficiency. It would be desirable in the art of burning fuels in furnaces to improve the heat transfer efficiency of the fuels. It would be especially desirable in the art to be able to evaluate compositions for use as additives to accomplish improved heat transfer quickly and with a minimum of expense.

### SUMMARY OF THE INVENTION

In one aspect, the invention is a process for evaluating compositions useful as additives for improving heat transfer in furnaces by comparing the emissivity of a first ash/additive admixture to the emissivity of a second ash/additive admixture wherein the emissivities of the ash/additive admixtures are measured at a temperature within an operating temperature range of a furnace of interest.

In another aspect, the invention is a process for evaluating a composition useful as an additive for improving heat transfer in furnaces by comparing the emissivity of an ash/additive admixture to the emissivity of the same ash but without the additive wherein the emissivities of the ash/additive admixture and the ash without the additive are measured at a temperature within an operating temperature range of a furnace of interest.

In still another aspect, the invention is a process for evaluating a composition useful as an additive for improving heat transfer in furnaces by comparing the emissivity of a first additive to the emissivity of a second additive wherein the emissivities is of the additives are measured at a temperature within an operating temperature range of a furnace of interest.

### DESCRIPTION OF THE PREFERRED EMBODIMENTS

In the practice of at least one embodiment of the method of the application, an additive is evaluated to determine if it can increase heat transfer efficiency in furnaces. While coal is presently the most common fuel that may be used in such furnaces, other fuels may also be used. For example, the process of the application may be used to evaluate the efficiency of additives used with coke, resid, heavy fuel oil, bitumen, and the like. Any fuel that burns to produce an ash or residue that may be treated to improve heat transfer may be used with process of the application.

The method of the application is directed to improving the heat transfer efficiency of furnaces, particularly furnaces employed in industrial applications. One type of such a furnace, the stoker-fired furnace, was developed to burn relatively large particles of coal, up to about 1.5 inches in diameter. Another type of furnace, the pulverized coal-fired furnace, which was developed for burning much smaller coal particles, e.g., where about 70% of the coal particles pass through a 200 mesh screen, may also be employed with the invention. Pulverized coal-fired furnaces have large steam generating capacities and are thus typically used in steam generating installations where at least 500,000 pounds of steam per hour are required. For example, the electric power generating industry has been one of the largest users of pulverized coal-fired furnaces, since large amounts of steam are required for the production of electric energy.

With either type of furnace, the coal added to the furnace combusts to produce heat. In some furnaces, the coal that does not instantly combust falls upon a grate on which the burning fuel bed resides. The grate moves, in some embodiments, at a very slow rate, e.g., from about 5 to 40 feet per hour, and eventually dumps the combustion by-products (namely, residual ash) into an ash pit or some other receptacle. Alternatively, the grate may be stationary but have the capability of being dumped at periodic intervals to remove the bed of accumulated ash.

One reason for the popularity of the spreader-stoker-fired furnace is its high superficial grate heat release rates of up to 750,000 BTU/hr-ft² and its low inertia due to nearly instantaneous fuel ignition upon increased firing rate. This high superficial grate heat release is obtained because of the relatively uniform distribution of the coal particles in the burning fuel bed on the grate, the relatively small depth of the layer of coal particles on the grate, and the intense combustion during the suspension phase above the burning fuel bed. The low inertia allows the spreader-stoker-fired furnace to respond rapidly to load fluctuations in steam demand, and hence in boiler load, which are common in industrial applications.

While several furnaces have been described in detail, the method of the disclosure may be employed with any furnace that burns a fuel that produces ash or other residue that may impact heat transfer efficiency.

In one embodiment, the method of the application is a process for evaluating compositions useful as additives for improving heat transfer in furnaces comprising admixing a composition of interest with ash to form an ash/additive admixture and comparing the emissivity of the ash/additive admixture to the emissivity of the ash without the composition of interest. While not wishing to be bound by any theories, it is never-the-less believed that efforts to evaluate additives by their ability to “darken” are ineffective.

It has been surprisingly discovered that, for example, the color of an admixture of ash and an additive at ambient temperatures is less effective for predicting the impact upon heat transfer efficiency than determining the emissivity of admixtures of ash and additives as compared to a control of the ash alone. By measuring emissivity within operating temperature of a furnace, a better determination of the ability of an admixture of ash and the additive to adsorb and then transfer heat to the heat transfer media of the furnace can be made.

If the ash coating the inside of the furnace is less emissive as compared to control, then the amount of energy radiated back in the space within the furnace is less and thus there is less heat energy to escape out of the stack of the furnace. This is especially significant in regard to the ash on the surface of the heat exchange tubes or other similar heat exchanger surfaces.

The evaluation of the method of the disclosure may be made in at least three different ways. In one embodiment, a composition of interest may be admixed with ash, heated to from about 700° C. to about 2000° C. [1050° C. in some embodiments] (for a furnace that operates in that range) and then a measurement made of its emissivity. In this same embodiment, the efficiency of the additive may be determined as a percentage of the emissivity of the ash alone. In an alternative embodiment, admixtures of additives and ash may be compared directly against each other. In still another embodiment, the additive may be compared without first admixing them with ash. In this latter embodiment, there may be inaccuracies due to ash/additive interactions resulting in synergy with respect to heat transfer efficiency.

The additives of the disclosure may be in any form that would be known to be useful to one of ordinary skill in the art of producing heat using a furnace. For example an additive can be a blend of two or more powdered metal oxides. In another example, the metal oxides may be in the form of a pellet formed by heating mixtures of the metal oxides. In some embodiments, the additive may be applied to coal or introduced into a furnace as a powder and, upon being subjected to the heat of a furnace, become a ceramic-like material.

Whether formed as a pressed pellet, sintered pellet, a mixture of pellets and powder or any combination thereof, the form of the additive may be small enough to readily form a comparatively non-emittive surface on the heat absorbing surfaces of the furnace. The size of the individual pellets or grains of the additive may vary with the conditions to which they are exposed during the combustion process.

The additive may be added to a fuel or it may be added directly to a furnace as the fuel is being fed to the furnace. In one embodiment, the additive is sprayed onto coal as a liquid prior to it being pulverized. In one such embodiment, a nozzle is used to perform the spraying. In another embodiment, the additive is sprayed onto coal as a liquid after it has been pulverized. In still another embodiment, the additive is introduced into coal as a solid. Another embodiment of the method of the disclosure includes introducing the additive as a solid prior to the coal being pulverized. The additive may be introduced into coal or a furnace using any method known to be useful to those of ordinary skill in the art.

The additives may be applied to the fuel, as discussed in regard to coal, and/or applied directly to ash after combustion is partially or fully complete. Generally, this may be performed by selecting where in the furnace the additive will be introduced. In most furnace types, the further downstream from the burning fuel that the additive is introduced, the more likely that the additive will come into contact with fuel ash rather combusting fuel.

The methods of the disclosure may be used advantageously to improve power plant operations. In some applications, more power may be produced per unit of coal burnt as fuel because less heat is lost due to “heat shift” caused by fuel ash emissivity. The efficiency of the power plants is evaluated based on the ratio of fuel input to electric power generated. It is a critical factor for power plant rating and forced derating due to low efficiency would result in great economic loss to the plant. In other applications, the need frequency for mechanically removing soot from the inside of a furnace may be reduced. Soot-blowing is a mechanical approach to resolving the ash emissivity issue. Frequent soot-blowing is not only expensive and time-consuming; also it adversely affects the mechanical integrity and reliability of the furnace due to tube wear and erosion caused by the soot-blowing operations. In still other applications, both of these advantages may be noted. In measuring the emissivity of the sample that has been heated to a furnace operating temperature, it may be desirable to make this measurement in a way that does not damage the equipment used to make the measurement. Since heat transfer efficiency is the object of the method of the disclosure, it may be desirable to make emissivity measurement in the IR range. For example, in one embodiment, the emissivity may be determined in a range of from about 1100 nm to about 1650 nm. Any spectrophotometer known of those of ordinary skill in the art to make such determination may be used with the method of the disclosure.

Samples may be heated using any method known to those of ordinary skill in the art to be useful. For example, in one embodiment, a laser may be used to heat a sample and an IR spectrometer used to measure emissivity. In an alternative embodiment an electrical resistance heater or oven may be used. In some embodiments, it may be desirable to separate the heat source from the spectrometer to prevent damage to the spectrometer. Lens and/or mirrors that can reflect or focus light in the IR range may be desirable for some embodiments of the methods of the application.

The method of the application offers a great advantage over the prior art as it may allow for a quick and simple test to be performed under furnace operation conditions to effectively screen out compounds that would have otherwise tested in a furnace. Operating furnaces, particularly large ones such as those employed in power generation, are sometimes not run in a steady state making comparison of additives difficult. Those employing the method of the application may be able to greatly reduce the number candidate compounds that would otherwise have been subject to test in plant trails, a difficult and often expensive proposition.

Those of ordinary skill in the art will well know how to evaluate candidates for use as additives with the method of the application for their particular units. For example, variables that would be likely to be considered would be cost and availability of the compounds, environmental issues such as whether the additive was environmentally undesirable and whether it tends to be lost up the stack and escape into the environment, ease of use, and the like. These could change with both location and furnace type.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

The effect of an additive on emittance of ash was evaluated using the following process:
a coal ash sample was formed into a pellet;
the pellet was heated to 1000° C. in a muffle furnace and the emitting radiation is collected by an IR-corrected 50× objective, and the light is focused into and analyzed by a HORIBA Jobin Yvon grating spectrometer with a CCD detector;
a pellet prepared from the same coal ash sample dosed with fixed amount of an additive was heated under the exact same conditions and the emittance was recorded the same manner; and
the emissivity modification effect of the additive was quantified by integrating emittance in the detected wavelength range (1144 nm to 1500 nm). The results are listed in Table 1.

TABLE 1

| | | Coal Ash Emissivity |
|---|---|---|
| Additive | Dosage (ppm) | Reduction, % |
| Pigment A | 10,000 | −13.5% |
| Pigment B | 10,000 | −8.5% |
| Pigment C | 10,000 | −26.2% |
| Pigment D | 10,000 | −16.3% |
| Pigment E | 10,000 | 12.6% |

### Example 2

The method of Example 1 was repeated substantially identically except that changing the level of a single additive was measured. Results are show below in the Table 2.

TABLE 2

| | | Coal Ash Emissivity |
|---|---|---|
| Additive | Dosage (ppm) | Reduction, % |
| Pigment E | 500 | 3.8% |
| Pigment E | 5,000 | 6.4% |
| Pigment E | 10,000 | 12.6% |

What is claimed is:

1. A process for evaluating a composition useful as an additive for improving heat transfer in furnaces comprising comparing an emissivity of an ash/additive admixture to an emissivity of the ash without the additive wherein the emissivities of the ash/additive admixture and the ash without the additive are measured at a temperature within an operating temperature range of a furnace of interest.

2. The process of claim 1 wherein the furnace of interest is selected from the group consisting of a stoker-fired furnace and a pulverized coal-fired furnace.

3. The process of claim 1 wherein the additive is a blend of two or more powdered metal oxides.

4. The process of claim 3 wherein the additive is in the form of a pellet.

5. The process of claim 1 wherein the additive/ash admixture is prepared by applying the additive to fuel used in a furnace.

6. The method of claim 5 wherein the fuel is coal.

7. The method of claim 1 wherein the operating temperature range of a furnace of interest is from about 700° C. to about 2000° C.

8. A process for evaluating compositions useful as additives for improving heat transfer in furnaces comprising comparing an emissivity of a first ash/additive admixture to an emissivity of a second ash/additive wherein the emissivities of the first and second ash/additive admixtures are measured at a temperature within an operating temperature range of a furnace of interest.

9. The process of claim 8 wherein the furnace of interest is selected from the group consisting of a stoker-fired furnace and a pulverized coal-fired furnace.

10. The process of claim 8 wherein the additive is a blend of two or more powdered metal oxides.

11. The process of claim 10 wherein the additive is in the form of a pellet.

12. The process of claim 8 wherein the first or second additive/ash admixture is prepared by applying the additive to fuel used in a furnace.

13. The method of claim 12 wherein the fuel is coal.

14. The method of claim 8 wherein the operating temperature range of a furnace of interest is from about 700° C. to about 2000° C.

15. A process for evaluating a composition useful as an additive for improving heat transfer in furnaces comprising comparing the emissivity of a first additive to the emissivity of a second additive wherein the emissivities of the additives are measured at a temperature within an operating temperature range of a furnace of interest.

16. The process of claim 15 wherein the furnace of interest is selected from the group consisting of a stoker-fired furnace and a pulverized coal-fired furnace.

17. The process of claim 5 wherein the additive is a blend of two or more powdered metal oxides.

18. The process of claim 17 wherein the additive is in the form of a pellet.

19. The process of claim 15 wherein the additive/ash admixture is prepared by applying the additive to fuel used in a furnace.

20. The method of claim 19 wherein the fuel is coal.

21. The method of claim 15 wherein the operating temperature range of a furnace of interest is from about 700° C. to about 2000° C.
